(19) United States
(12) Patent Application Publication
(10) Pub. No.: US 2013/0039721 A1
(43) Pub. Date: Feb. 14, 2013

(54) Anchor Nail

(71) Applicant: HSUEH-PIN CHANG, Taichung City (TW)

(72) Inventor: HSUEH-PIN CHANG, Taichung City (TW)

(21) Appl. No.: 13/206,517

(22) Filed: Aug. 10, 2011

(51) Int. Cl. F16B 15/00

(52) U.S. Cl. 411/448

(57) ABSTRACT

An anchor nail comprises a nail body being cut from a metal sheet and folded into shape. The nail body has an anchor strip substantial cut from a central portion of the nail body, whereby the nail body can be stricken to pierce the work pieces together with the anchor strip by striking the striking head of the nail body, so that the striking head can be in flush with an outer surface of the work pieces whereas the striking section of the anchor strip can extend out of the outer surface of the work pieces. Thereafter, the anchor strip can be stricken to move into the work pieces to be in flush with the striking head of the nail body so that the slightly curved section can be further curved so as to anchor the work pieces. The anchor nail can enhance the combining strength of the work pieces.

### TECHNICAL FIELD OF THE INVENTION

The present invention relates to an anchor nail and, more particularly, to an anchor nail that can enhance the combining strength of work pieces.

### DESCRIPTION OF THE PRIOR ART

According to wood industry, collated finish nails are usually employed for fastening two wooden planks or boards. Conventional collated finish nails, as shown in FIG. 1, comprises a straight shank 11 and a head 12, both of which form a generally T-shaped structure. Since the combining strength of a T-shaped structure is not strong enough to resist the external force for some wooden material, the planks or boards of the wooden material fastened by the conventional nails are prone to become loose and be taken apart.

In view of the foregoing, based on the long-term experiences of developing and manufacturing various automatic equipments, special machines, molds and fixtures, and after constant efforts on the experiments and innovation of nail products, the applicant has contrived an anchor nail to overcome the drawback of the conventional nails.

### SUMMARY OF THE INVENTION

The primary object of the present invention is to provide an anchor nail that can enhance the combining strength of work pieces.

According to one feature of the present invention, the anchor nail comprising a nail body being cut from a metal sheet and folded into shape. The nail body has an anchor strip being substantial cut from a central portion of the nail body, whereby the nail body can be stricken to pierce the work pieces together with the anchor strip by striking the striking head of the nail body, so that the striking head can be in flush with an outer surface of the work pieces whereas the striking section of the anchor strip can extend out of the outer surface of the work pieces. Thereafter, the anchor strip can be stricken to move into the work pieces to be in flush with the striking head of the nail body so that the slightly curved section of the anchor strip can be further curved so as to anchor the work pieces. With the anchor nail, the work pieces can be combined more firmly and prevent the combined work pieces from being taken apart.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of collated finish nails of prior art.

FIG. 2 is a 3-dimensional view of an anchor nail according to a first embodiment of the present invention.

FIG. 3 is a front view and a side view of the anchor nail according to the first embodiment, which shows a state of the anchor nail when the nail body thereof is stricken to pierce the work pieces.

FIG. 4 is a front view and a side view of the anchor nail according to the first embodiment, which shows a state of the anchor nail when the anchor strip thereof is stricken to move into the work pieces.

FIG. 5 is a 3-dimensional view of an anchor nail according to a second embodiment of the present invention.

FIG. 6 is a front view and a side view of the anchor nail according to the second embodiment, which shows a state of the anchor nail when the nail body thereof is stricken to pierce the work pieces.

FIG. 7 is a front view and a side view of the anchor nail according to the second embodiment, which shows a state of the anchor nail when the anchor strip thereof is stricken to move into the work pieces.

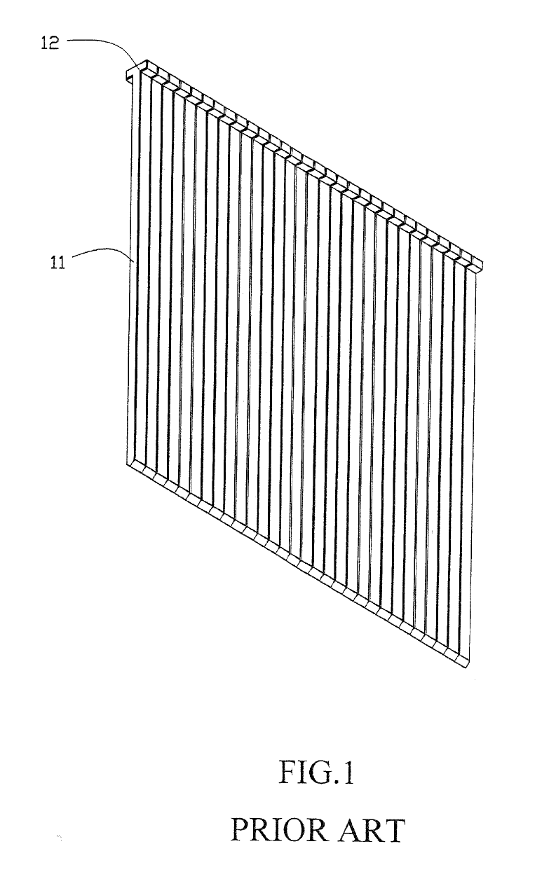

### DETAILED DESCRIPTION OF THE PREFERRED EMBODIMENTS

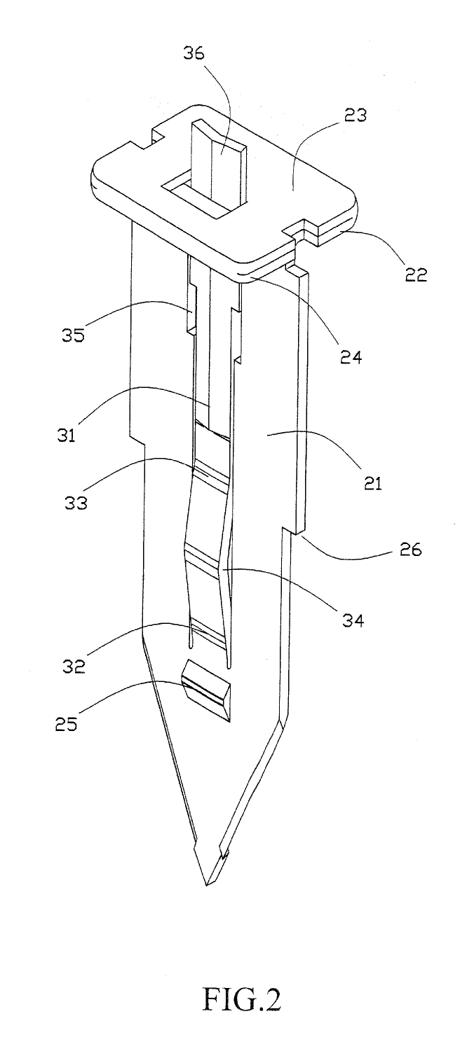

Turning now to FIG. 2, an anchor nail according to a first embodiment of the present invention comprises a nail body 21 being cut from a metal sheet and folded into shape. The nail body 21 has an anchor strip 31 being substantially cut from a central portion of the nail body 21. The nail body 21 includes a lower creased section 32, a slightly curved section 34 above the lower creased section 32, a step section 35 above the slightly curved section 34 for cooperatively engaging with the nail body 21, and a striking section 36 at a top thereof, in which the slightly curved section 34 has at least one crease 33 formed thereon. The nail body 21 is formed with a striking head 23 by folding a top portion of the nail body 21. The striking head 23 is located below the striking section 36 of the anchor strip 31, The striking head 23 has a right side part 22 and a left side part 23, both of which are substantially perpendicular to the anchor strip 21 and between which an opening is defined to be inserted through the striking section 36 of the anchor strip 31. The nail body 21 is provided with a projection 25 below the slightly curved section 34 of the anchor strip 31, and is provided with steps 26 respectively at two opposite sides thereof.

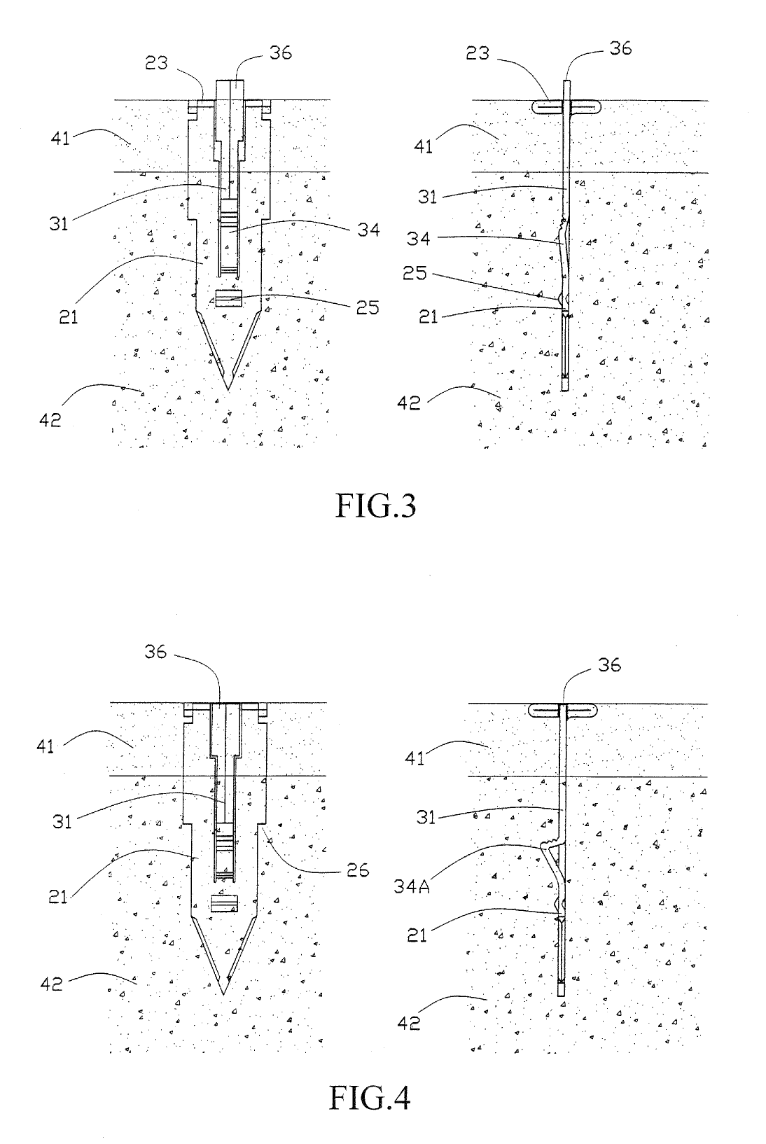

Turning next to FIG. 3, in operation, a user may employ a nail gun to conduct the operation of piercing the anchor nail. The projection 25 of the nail body 21 can act as a guide for facilitating movement of the anchor strip 21, so that the nail body 21 can be stricken to pierce the work pieces 41, 42 together with the anchor strip 31 by striking the striking head 23 of the nail body 21, so that the striking head 23 can be in flush with an outer surface of the work pieces 41, 42 whereas the striking section 36 of the anchor strip 31 can extend out of the outer surface of the work pieces 41, 42. As shown in FIG. 4, the steps 26 formed at two opposite sides of the nail body 21 can stop the nail body 21 from movement with the anchor strip 31 when striking the striking section 36 of the anchor strip 31, so that the anchor strip 31 can be stricken to move into the work pieces 41, 42 to be in flush with the striking head 23 of the nail body 21, so that the slightly curved section 34 can be further curved so as to anchor the work pieces 41, 42, the slightly curved section being now at a state indicated at 34A. At this moment, the step section 35 (see FIG. 2) can engage with the nail body 21 to prevent the anchor strip 31 from further movement into the work pieces 41, 42. With the anchor nail of the present invention, the work pieces 41, 42 can be fastened rapidly and conveniently.

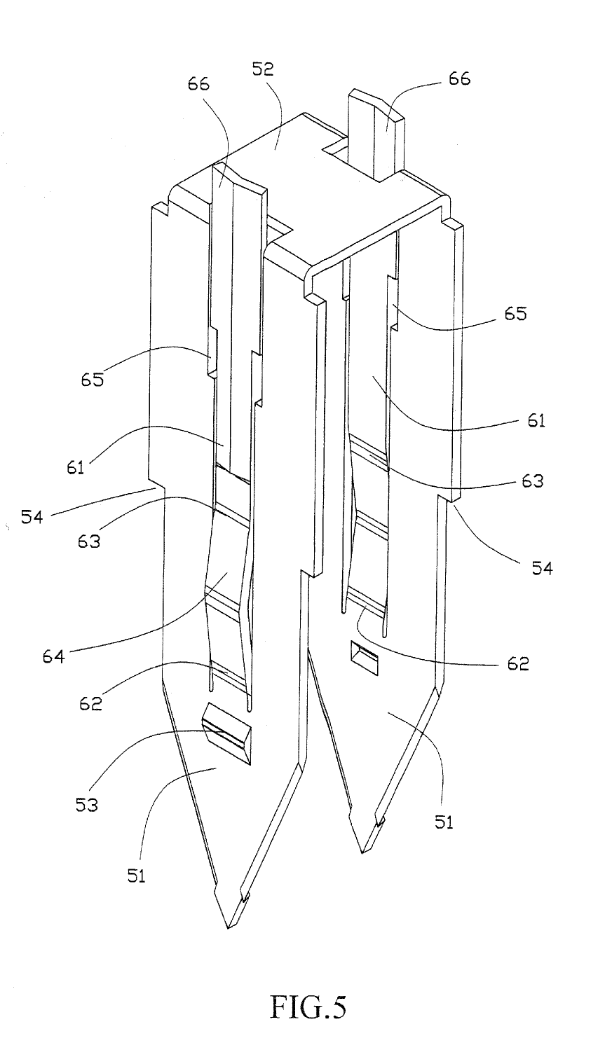

Turning now to FIG. 5, for easy of illustration, different parts having the same structure will be indicated at the same numeral. As shown, an anchor nail according to a second embodiment of the present invention comprises a main body being cut from a metal sheet and folded into shape. The main body has two nail bodies 51 corresponding to each other and is formed with a striking plate 52 between the nail bodies 51 to substantially form as an U-shaped structure. Each nail body 51 has an anchor strip 61 being substantially cut from a central portion of the respective nail body 51. Each nail body 51 includes a lower creased section 62, a slightly curved section 64 above the lower creased section 62, a step section 65 above the slightly curved section 64 for cooperatively engaging with the respective nail body 51, and a striking section 66 at a top thereof The slightly curved section 64 has at least one crease 63 formed thereon. The striking plate 52 is located below the striking sections 66 of the anchor strips 61. The striking plate 52 is substantially perpendicular to the anchor strips 66 and defines two openings respectively at two junctions of the nail bodies 51 and the striking plate 52. Each opening can be inserted through a respective striking section 66. Each nail body 51 is provided with a projection 53 below the slightly curved section 64 of the respective anchor strip 51, and is provided with steps 54 respectively at two opposite sides thereof;

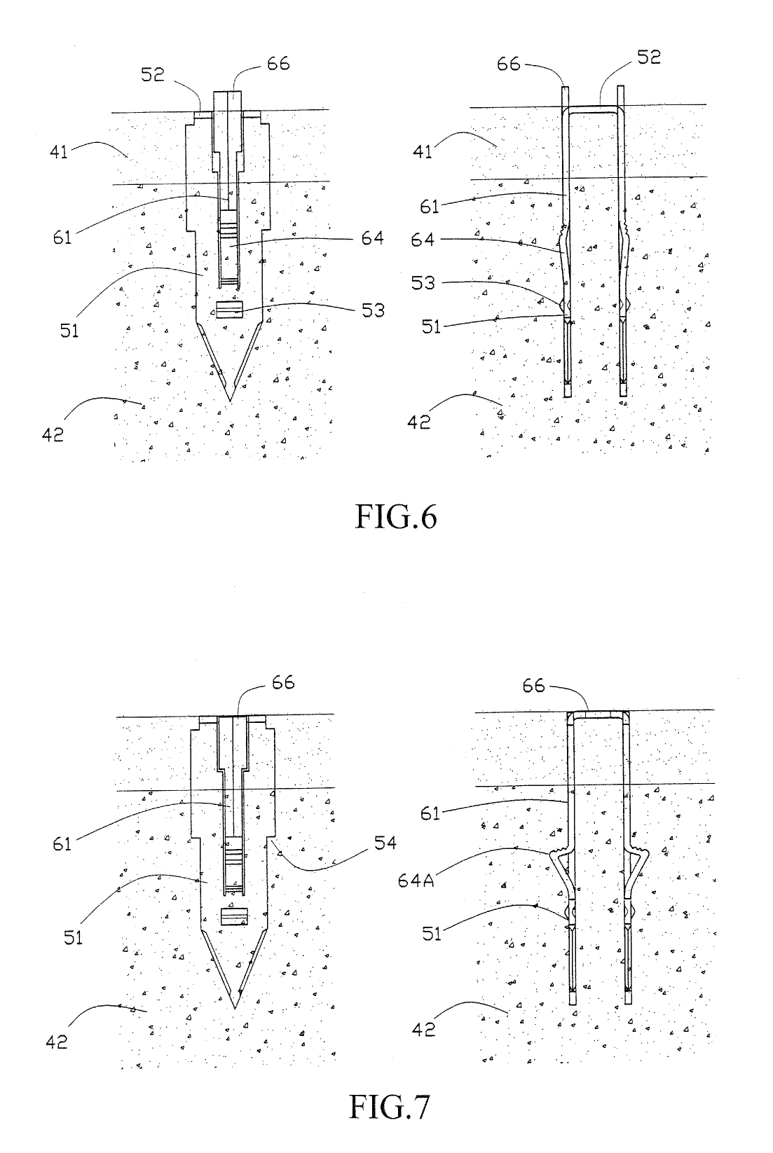

Turning next to FIG. 6, in operation, a user may employ a nail gun to conduct the operation of piercing the anchor nail. The projections 53 of the nail bodies 51 can each act as a guide for facilitating movement of each anchor strip 61, so that the nail bodies 51 can be stricken to pierce work pieces 41, 42 together with the anchor strips 61 by striking the striking plate 52, so that the striking plate 52 can be in flush with an outer surface of the work pieces 41, 42 whereas the striking sections 66 of the anchor strips 61 can extend out of the outer surface of the work pieces 41, 42. As shown in FIG. 7, the steps 54 formed at two opposite sides of the nail bodies 51 can stop the nail bodies 51 from movement with the anchor strips 61 when striking the striking sections 66 of the anchor strips 61, so that the anchor strips 61 can be stricken to move into the work pieces 41, 42 to be in flush with the striking plate 52 so that the slightly curved sections 64 can be further curved so as to anchor the work pieces 41, 42, the slightly curved section being now at a state indicated at 64A. At this moment, the step sections 65 (see FIG. 5) can engage with the nail bodies 51 to prevent the anchor strips 61 from further movement into the work pieces 41, 42. With the anchor nail of the present invention, the work pieces 41, 42 can be fastened rapidly and conveniently.

Although the nail body of the present invention has an acute structure at the bottom thereof, it is not a primary feature of the present invention; the nail body may have other shapes at the bottom thereof Thus, a further description for the bottom structure of the nail body is eliminated.

In light of the foregoing, the anchor nail of the present invention has an excellent structure that can overcome the drawback of the conventional nails to allow the operation of fastening work pieces more rapidly and conveniently.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An anchor nail comprising:
a nail body being cut from a metal sheet and folded into shape, said nail body having an anchor strip being substantially cut from a central portion of said nail body, said anchor strip including a lower creased section, a slightly curved section above said lower creased section, a step section above said slightly curved section for cooperatively engaging with said nail body, and a striking section at a top thereof, said slightly curved section having at least one crease formed thereon, said nail body being formed with a striking head by folding a top portion of said nail body, said striking head having a right side part and a left side part substantially perpendicular to said anchor strip, said striking head being located below said striking section of said anchor strip, said nail body being provided with a projection below said slightly curved section of said anchor strip, and being provided with step sections respectively at two opposite sides thereof;
whereby said projection of said nail body can act as a guide for facilitating movement of said anchor strip, so that said nail body can be stricken to pierce work pieces together with said anchor strip by striking said striking head of said nail body, so that said striking head can be in flush with an outer surface of the work pieces whereas said striking section of said anchor strip can extend out of the outer surface of the work pieces; said steps formed at two opposite sides of said nail body can stop said nail body from movement with said anchor strip when striking said striking section of said anchor strip, so that said anchor strip can be stricken to move into the work pieces to be in flush with said striking head of said nail body so that said slightly curved section can be further curved so as to anchor the work pieces.

2. An anchor nail comprising:
a main body being cut from a metal sheet and folded into shape, said main body having two nail bodies corresponding to each other and being formed with a striking plate between said nail bodies to substantially form as a U-shaped structure, each nail body having an anchor strip being substantially cut from a central portion of the respective nail body, each said anchor strip including a lower creased section, a slightly curved section above said lower creased section, a step section above said slightly curved section for cooperatively engaging with said nail body, and a striking section at a top thereof, said slightly curved section having at least one crease formed thereon, said striking plate being located below said striking sections of said anchor strips, each said nail body being provided with a projection below said slightly curved section of the respective anchor strip, and being provided with steps respectively at two opposite sides thereof;
whereby said projections of said nail bodies can each act as a guide for facilitating movement of each said anchor strip, so that said nail bodies can be stricken to pierce work pieces together with said anchor strips by striking said striking plate, so that said striking plate can be in flush with an outer surface of the work pieces whereas said striking sections of said anchor strips can extend out of the outer surface of the work pieces; said steps formed at two opposite sides of said nail bodies can stop said nail bodies from movement with said anchor strips when striking said striking sections of said anchor strips, so that said anchor strips can be stricken to move into the work pieces to be in flush with said striking plate so that said slightly curved sections can be further curved so as to anchor the work pieces.
